(19) United States
(12) Patent Application Publication
(10) Pub. No.: US 2005/0256848 A1
(43) Pub. Date: Nov. 17, 2005

(54) System and method for user rank search

(75) Inventors: Sherman Robert Alpert, Briarcliff Manor, NY (US); Thomas A. Cofino, Rye, NY (US); John Karat, Greenwich, CT (US); John George Vergo, Yorktown Heights, NY (US); Catherine Gody Wolf, Katonah, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 10/844,996

(22) Filed: May 13, 2004

(51) Int. Cl. G06F 7/00

(52) U.S. Cl. 707/3

(57) ABSTRACT

A method and apparatus are disclosed for ranking the results of a document search by identifying a prior, similar search and assigning a weight to each document based on whether the document was selected by a user of the prior search. The assigned weights are utilized to rank the documents identified by the document search in order of their relevance to the search terms. The search terms of the document search and information describing the selections made by a user of the document search are then stored to facilitate the assignment of weights to documents in future searches. According to another aspect of the invention, the weight assigned to a document is correlated to a degree of closeness of search terms of a prior search and search terms of a new document search. For example, a degree of closeness measurement is defined that correlates to a number of synonyms common between the search terms of a prior search and the search terms of a new document search.

### FIELD OF THE INVENTION

This invention relates generally to systems and methods for information search and retrieval, and more particularly, to computing the relevancy of documents or web pages delivered by a search and retrieval system by utilizing user selections of documents identified in prior search results.

### BACKGROUND OF THE INVENTION

The World Wide Web (“the web”) is a repository of information organized into web pages and other documents (numbering over 1 trillion). Information search and retrieval systems have been developed to aid users in searching for information on the web. Conventional systems present a user with a set of pages or documents (or both) that are relevant and responsive to a set of query terms issued by the user, and more specifically, attempt to place the most relevant response as the first entry in the hitlist. Since web pages are essentially a type of document, web pages and documents will hereinafter be referred to as web documents.

Conventional methods of determining relevance of a document are based on matching the user's query term(s) to an index of all the terms in the web documents being searched to generate a hitlist. The hitlists of traditional search systems contain pointers (or “entries,” typically, Uniform Resource Locators (URLs)) to the desired information. The hitlist entries are usually ranked in terms of calculated relevance in regard to the user supplied search term(s) in an order from most relevant to least relevant. When a user selects a hitlist entry, the web page or document pointed to by the hitlist entry is then presented (displayed) to the user.

It is well known in the art that search systems most often return extensive hitlists in response to a user's query and that users most frequently look only at the first page of the hitlist returned by the search system, and more specifically, look only at the entries which appear on the displayed page. Ensuring that the most relevant entry is as close as possible to the first entry in the hitlist is therefore crucial to ensuring the usefulness of the search system for users.

Newer ranking methods often employ algorithms that take advantage of the linked structure of the web to make the search more efficient and effective. U.S. patent application No. 2002/0123988 discloses a search algorithm that uses link analysis to determine the quality of a web page. In general, pages that have many links pointing to them are assumed to be good sources of information (these pages are known as “authorities”). Similarly, pages that point to many other pages are assumed to be high quality reference sources (these pages are known as “hubs”). At the core of both these techniques is the assumption that links are an implicit “stamp of approval” or “vote for quality” by the author of the page since a human being created a link on a page and published the page on the web.

In addition, an earlier popularity-based search engine, DirectHit, ranked web sites based on traffic data. DirectHit tabulated the aggregate traffic per web site across all user queries to calculate the traffic data. For example, if, in aggregate, more users visited msnbc.com than visited reuters.com (i.e., selected and visited the msnbc.com hitlist entry than selected and visited the reuters.com hitlist entry), DirectHit would then raise the relevancy score of msnbc.com compared to the relevancy score of reuters.com in subsequent hitlists that contained entries from both web sites, thus reflecting the greater amount of user traffic going to msnbc.com over reuters.com.

All of the methods presented above, however, have shortcomings. Methods that rely on analyzing terms can easily be fooled by a page author who alters the content of the page so as to falsely increase the value of the relevance calculation for a particular document. Methods that utilize links also tend to favor pages that have simply existed longer, since these pages tend to have more links associated with them simply because they have been viewed by more authors (who then link to them). Clearly, there is a need for new methods to determine document relevance to overcome these problems and improve the usefulness and effectiveness of information search and retrieval systems and, in particular, to improve the accuracy of relevance rankings.

### SUMMARY OF THE INVENTION

Generally, a method and apparatus are provided for ranking the results of a document search by identifying a prior, sufficiently similar search and assigning a weight to each document based on whether the document was selected by a user of the prior search. As used herein, a “sufficiently similar” search shall include those searches that have the same search terms or search terms within a predefined threshold for a similarity metric. The assigned weights are utilized to rank the documents identified by the document search in order of their relevance to the search terms. The search terms of the document search and information describing the selections made by a user of the document search are then stored to facilitate the assignment of weights to documents in future searches.

According to another aspect of the invention, the weight assigned to a document is based on an order of selection of two or more documents by the user or based on a position of the document in a hitlist. It is also disclosed that the weight assigned to a document can be correlated to a ratio of the number of times the document was selected in a prior search and the number of prior search result hitlists that have been generated.

According to another aspect of the invention, the weight assigned to a document is correlated to a degree of closeness of search terms of a prior search and search terms of a new document search. For example, a degree of closeness measurement is defined that correlates to a number of synonyms common between the search terms of a prior search and the search terms of a new document search.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of one preferred embodiment of the search and retrieval system of the present invention;

FIG. 2 illustrates an exemplary query record database of the present invention;

FIG. 3 is a flowchart of an exemplary method for selecting a ranking algorithm;

FIG. 4 is a flowchart of an exemplary ranking method for organizing documents based on query-specific user selection information;

FIG. 5 is a flowchart of an alternate embodiment of the ranking method of FIG. 4; and

FIG. 6 illustrates the intermediate and final results of processing a search result utilizing the exemplary method of FIG. 4.

### DETAILED DESCRIPTION

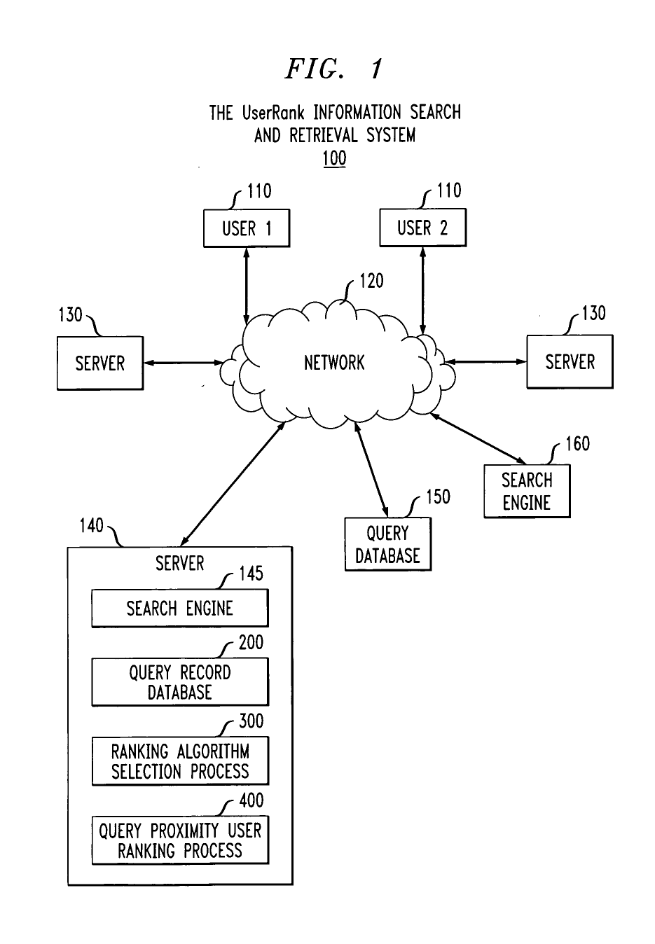

FIG. 1 illustrates an information search and retrieval system 100 in which the methods, algorithms and apparatus consistent with the present invention may be implemented. The system 100 may include one or more client devices 110 which are connected through a network 120 to one or more servers 130 and 140. The network 120 may be any type of wired or wireless network, including a local area network (LAN), a wide area network (WAN), the Internet, or any combination of such networks. In FIG. 1, two clients 110 are shown connected to three servers 130 and 140, search engines 145 and 160, and a Query Database (QD) 150 through network 120 to illustrate a system consistent with the present invention. In a real implementation, there may be any number of clients and servers, the query database 150 may span multiple databases, and the network 120 may be a combination of many networks. Clients may perform the server function, and servers may perform the client function.

The servers 130 and 140 may include any type of computer system or any type of dedicated single or fixed multifunction electronic system, any of which is capable of connecting to the network 120 and communicating with the clients 110. The server 140 may optionally contain one or more of the following: the search engine 145, query record database 200, the ranking algorithm selection process 300, or query proximity user ranking process 400; the system may also contain a separate search engine 160. The query database 150 may include any type of database that can store the types of data used for queries, as well as the types of data used to represent the selected documents. The servers 130 and 140 may themselves perform the functions of the query database 150, and they may store the documents themselves in any storage mechanism they may have.

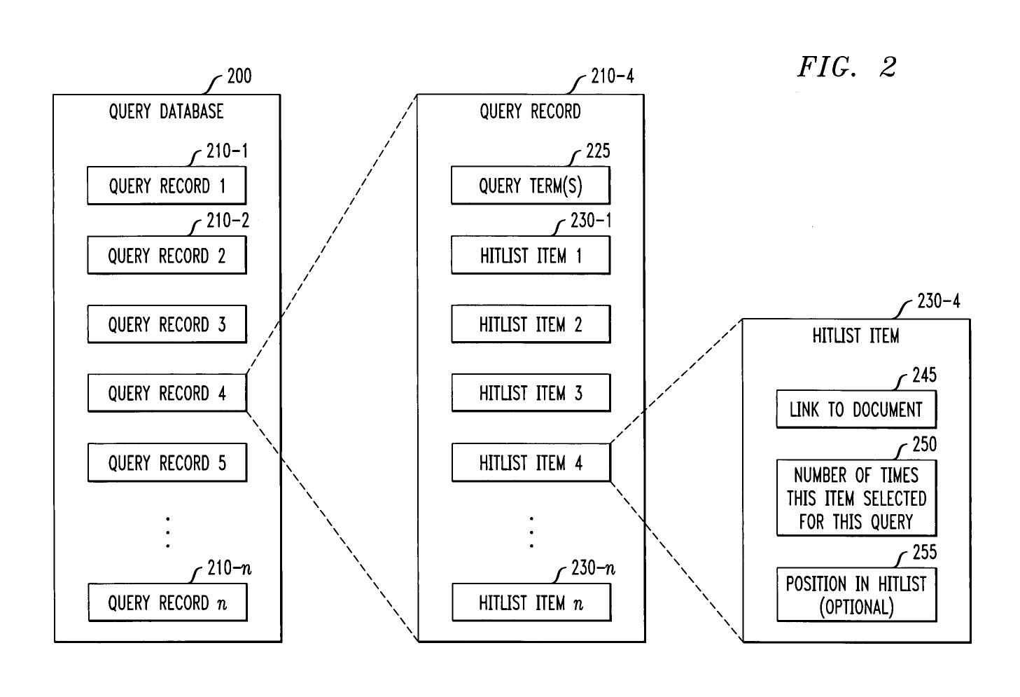

FIG. 2 illustrates an exemplary query record database 200 of the present invention. The query record database 200 contains a query record 210 for each recorded prior search. Each query record 210 contains one or more query terms in a query term entry 225 and one or more search result hitlists (hitlist items 230). Each hitlist item 230 contains a link to document 245, a record of the number of times the associated document was selected for the associated query 250, and an optional position in hitlist entry 255 (identifying the position of the hitlist item 230 in the query record 210).

Traditional information search and retrieval systems do not factor into the relevancy calculation the prior selections of users that issued the same or substantially similar queries. The present invention, however, recognizes that the analysis of hitlist selections of earlier users can provide insight into the relevancy of a document identified in a search result. Thus, a search system is disclosed that utilizes the human judgments made by earlier search users who try to select the most relevant hitlist entries from their search results. By keeping track of individual queries, and the corresponding user hitlist selections, the methods of the present invention are better able to recognize and appropriately rank the most relevant hitlist entries for each unique query. While search engines such as Google take usage information into account on a page by page basis, this only partly factors in these prior user selections since it ignores the context of the queries of the prior users.

Thus, the present invention recognizes that, just as the static structure of the web can yield insight into people's perception of the quality of pages (as evidenced by the number of links pointing to and from pages), the dynamic, behavioral information gathered by observing user selections from among the items on a search hitlist can be translated into measures of document relevance. This behavioral information can be used to alter the presentation of search engine results, with the highest quality, most important pages being given a higher position in the search result hitlist.

As users examine documents corresponding to the hitlist entries presented by the search system, the users attempt to determine whether these documents are relevant to the specific query terms. They are providing additional information that, if utilized by the search system, will improve relevancy scoring and document ranking and, thereby, improve the usefulness of the search system. Each time a user selects a hitlist entry from the hitlist returned by the search system, the user is making an implicit and explicit evaluation of the relevancy of the entry selected with respect to the other entries on the hitlist. Every time a web site visitor clicks on a search result hitlist entry, it can be thought of as a “vote of quality” for the referent page. By tracking these user selections and using them to alter the relevancy rankings of hitlist items, the search system can improve the relevancy of the hitlist entries it generates. Thus, according to one aspect of the present invention, a method for grouping similar queries together is disclosed to improve the relevancy of hitlist entries for a new search (that is similar to earlier queries), thereby allowing the human judgments made about the entire set of earlier hitlist entries to influence the rank order of the current hitlist. The present invention uses the earlier user selections as votes on the quality of the hitlist entries, and as a component of the relevance calculations which provide a primary input to the ordinal ranking of hitlist entries.

The present invention views different people who conduct a search as having the same goal or set of goals in seeking documents that satisfy the search terms. For example, let A equal the search terms for a search, and call this search Search(A). Once Search(A) is executed, the user is presented with a set of search results in the form of a hitlist. As the user selects entries from the hitlist, each selection is viewed as a “vote for quality” for the selected entry. Each vote has weight in the context of the Search(A).

The search terms of a search ultimately determine the set of hitlist entries which satisfy the search. Multiple searches with similar search terms will produce search result hitlists that contain similar entries. Query proximity is a measure of how close (semantically), or similar, two sets of search terms are to each other. As query proximity increases, that is, as the two sets of search terms become more similar to each other, the set of search result hitlist entries become more similar. Thus, the closer two sets of result hitlists are to each other, the more relevant a prior user's “vote for quality” during a prior search is relevant to the current search. Therefore, the user's selection of a hitlist entry on a prior search, where the query proximity of the two sets of search terms is within a certain degree of closeness, should increase the weight of the prior search hitlist entry selection for the new search, moving that hitlist entry closer to the top of the new search hitlist than it would otherwise be.

Although there may also be more than one user goal associated with Search(A), subsequent users who execute Search(A) can retrieve more relevant search results if they are presented with documents that have been frequently selected by previous users who have executed Search(A) (or a similar search), since these selections are an indication of greater relevancy of the selected pages and/or documents. For a given Search(A), session information is tracked and the series of hitlist entries the user selected is recorded (tracking session information is well known in the art). Given this information, there are a number of alternative embodiments of this invention to reorder the hitlist for subsequent searches:
1. For a given Search (A), if there are multiple selections made by a user from the hitlist, the final selection from the hitlist is given the greatest weight. Each selection made prior to the final selection is considered a “vote for quality,” but the weight of the vote for a non-final selection is given less weight than the weight for the final selection for that search. The weight of the nonfinal votes could be positive, zero or negative.
2. If an entry in the hitlist is presented in position n in the list and it is selected before an entry at position k, where n>k, then page n is given a higher UserRank than page k for Search(A).
3. As in embodiment 2 above, where selection n is given a weight that correlates to its position in the hitlist.
4. As in embodiment 3 above, where selection n is given a weight correlated to the page on which it appears in the hitlist if the hitlist is too long to fit onto a single display page.

An additional preferred embodiment to determine weightings for hitlist entries is to value selections made by experts as having more weight than selections made by non-experts. Many kinds of users can be included in the expert category, including acknowledged subject matter experts, well known brilliant people, college professors, authors, or frequent searchers; the non-expert category would include average searchers, non-college graduates, and occasional searchers. Of course, there can be many intermediate categories between experts and non-experts, and the weights for these categories would fall between those of experts and non-experts.

Similarly, a user who selects documents that appear after the first page of a hitlist can be considered a type of expert user, or at least a user who thoroughly evaluates the entries in the hitlist. Thus, another preferred embodiment of the present invention gives a greater weight to selections made by a user who selects documents that appear after the first page of a hitlist.

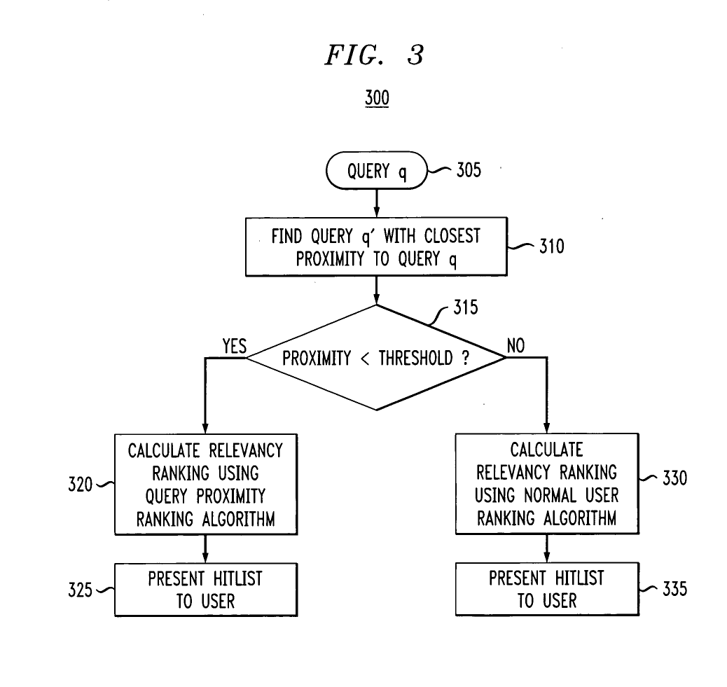

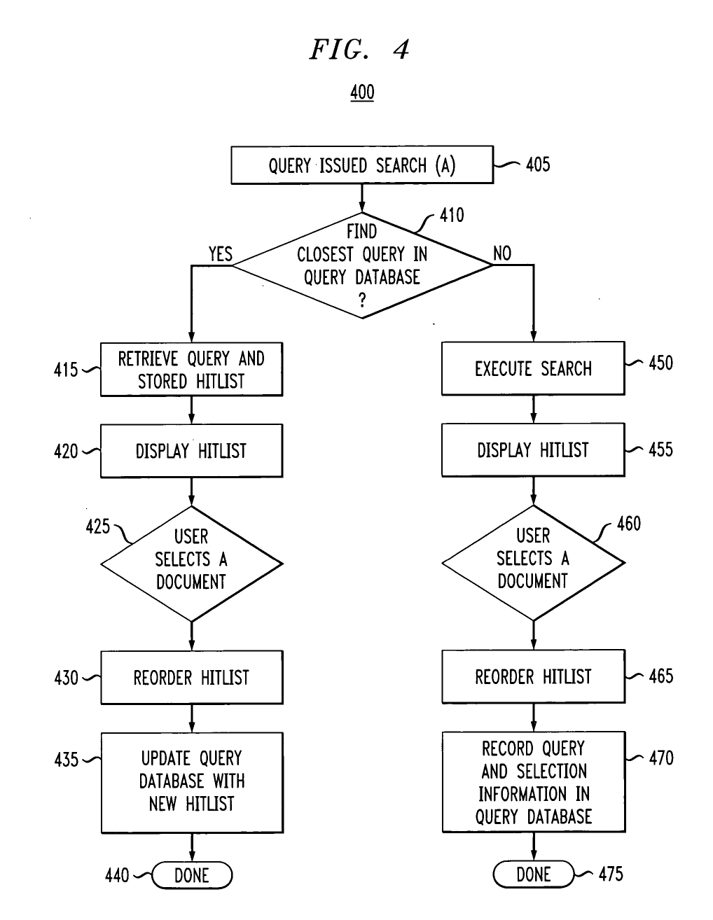

One aspect of the invention uses query proximity techniques that evaluate term distance, e.g., determining if the terms are synonyms in an online thesaurus, or if they have sufficient co-occurence in documents on the web. In a preferred embodiment of the invention, scores are normalized between 0 and 1, with 0 indicating identical terms and 1 indicating unrelated terms. FIG. 3 is a flowchart for an exemplary method 300 for selecting a ranking algorithm. In the exemplary method 300, the query proximity between a current search and the “closest” previous search is used to determine whether a query proximity or normal ranking algorithm is used. During process 300, a user enters a query q during step 305. At step 310, a search is performed to find the query q′ that has the closest proximity to query q. During step 315, a test is performed to determine if the proximity between queries q and q′ is greater than a threshold value. If, during step 315, it is determined that the proximity between queries q and q′ is less than the threshold value, then the relevancy ranking is calculated using a query proximity ranking algorithm (step 320); otherwise, the relevancy ranking is calculated using a normal user ranking algorithm, as discussed further below in conjunction with FIG. 4, (step 330). The hitlist generated is then presented during step 325 or step 335. Note that the threshold may be set to zero so that proximity is always used.

In one embodiment, synonyms shared between two sets of query terms, signifying closer query proximity, generate a higher query proximity score than two sets of query terms without synonyms. Thus, searching for “laptop Ethernet card” and “notebook Ethernet card” results in determining that the two sets of query terms are in closer query proximity than “laptop Ethernet card” and “computer Ethernet card,” since “computer” is not as synonymous with “laptop” as is “notebook.” In some embodiments, taxonomic relationships can be used to make calculating query proximity more exact.

FIG. 4 illustrates a flow diagram of an exemplary Query Proximity User Ranking method 400 for organizing documents based on query-specific user selection information, where PA(i) is the web page or document pointed to by the ith entry in the hitlist for Search(A) (prior to the execution of this algorithm). The term PA(i) can be used to denote equally the hitlist entry and/or the web page or document to which it points.

During process 400, a user issues a query (Search (A)) during step 405. During step 410, a search of the query record database 200 is performed to determine if a previous Search (A) was conducted by a user. If it is determined that a previous Search (A) was not conducted by a user, then Search (A) is performed (step 450) and the resulting hitlist is displayed (step 455). The user then selects one or more documents from the hitlist (step 460) and, following the completion of step 460, the hitlist is reordered in accordance with the user's selections (step 465). The search terms, hitlist, and selection information are then recorded in a new query record 210 in the query record database 200 (step 470).

If, however, during step 410, it is determined that a previous Search (A) was conducted by a user, then the query record 210 associated with Search (A) is retrieved (step 415) and the hitlist from the query record 210 is displayed (step 420). The hitlist can optionally be updated with new documents. During step 425, the user selects one or more documents from the retrieved hitlist. Once the selection of documents (step 425) is completed, the recorded hitlist is reordered based on the selections of the current user (step 430). The search terms, reordered hitlist (from step 430), and selection information (from step 425) are recorded in the query record 210 associated with Search(A) in the query record database 200 (step 465).

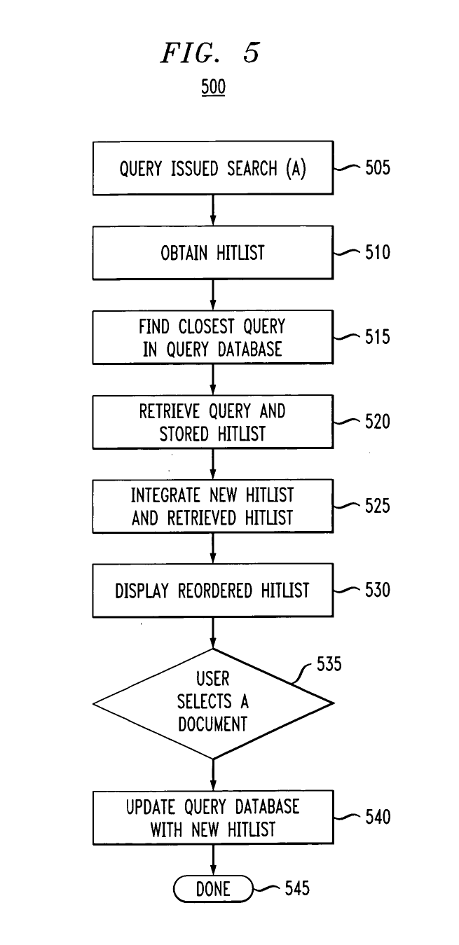

FIG. 5 illustrates a flow diagram of an alternate embodiment of the Query Proximity User Ranking method 400 that integrates the results of a new search with the selections of a user(s) who conducted a previous similar search(es). In process 500, a user issues a query for Search(A) to a search engine 160 (step 505). The search engine 160 returns a hitlist containing documents entries sorted by their relevance to the query terms (step 510). A search is also conducted to find the previous search(es) that are within a certain proximity of Search(A) (step 515) and the query record and hitlist of the discovered previous search(es) is retrieved (step 520).

During step 525, the new hitlist generated by the search engine 160 is integrated with the retrieved hitlist. Someone skilled in the art should be able to do this] Newly discovered documents are given initial UserRank weightings and integrated into the overall hitlist. A variety of algorithms can be used to assign the initial weightings. The integrated hitlist is then displayed in step 530. The remaining steps in the process are similar to those of process 400, i.e. the user selections are tracked, the hitlist is reordered, and a new query record 210 is recorded in the query database 200.

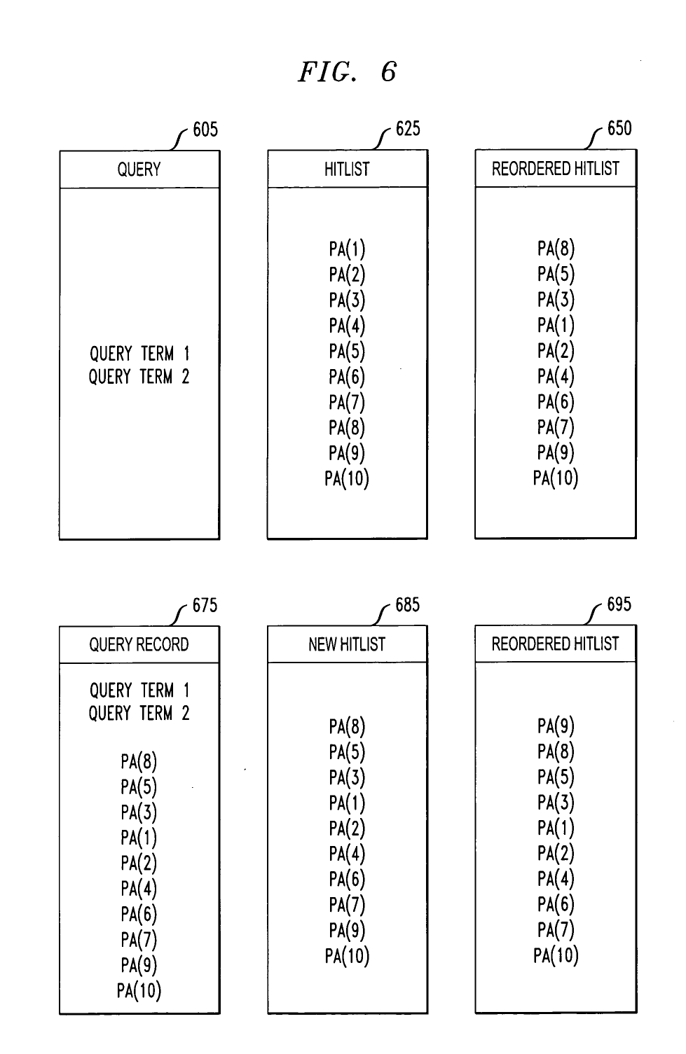

FIG. 6 illustrates the intermediate and final results of processing a search result utilizing the exemplary method of FIG. 4. As illustrated in FIG. 6, if a user issues a query 605 to execute Search(A), the entries PA(1), PA(2) . . . PA(10) are displayed in a hitlist 625 (assuming there are only 10 relevant documents or web pages). If, over the course of a searching session, the user selects, for example, PA(5), followed by PA(3) and, finally, PA(8), a new reordered hitlist 650 is generated. During this process, PA(5) and PA(3) are known as intermediate selections, and PA(8) is known as the final selection. The reordered hitlist 650 is stored in a new query record 675. When a second user executes Search(A) at a later time, the order of the entries on the latter hitlist (new hitlist 685) that the second user sees will change based on the selections of the first user. A reordered hitlist 695 will then be generated based on the selections of the second user.

There are many different orderings which could result depending on the algorithm selected. One method for calculating the new ordering (UserRank) consistent with this invention is to use the frequency that users select a page from the results list to determine UserRank. UserRank for the i^{th} entry in the hitlist, in this case, equals the number of times the entry i was selected by prior users, divided by the total number of times it was shown to prior users for that query or similar queries. If two or more pages have the same selection frequency, then the relative order for the two documents should be the same as the normal search system order without reference to UserRank, based on the normal search system calculated document relevance. Given the above example, the new order of entries in the hitlist would be:
PA(3), PA(5), PA(8), PA(1), PA(2), PA(4), PA(6), PA(7), PA(9), PA(10).

Alternate methods for calculating UserRank take the order of selection of hitlist entries into account, giving some selections more or less weight, depending on the algorithm used. Three examples of alternate orderings consistent with the invention will illustrate how the intermediate selections can be factored into the calculation of relevancy. There are many other algorithms that could be used. In all three examples, the final selection is recognized as being of the greatest importance to the user. UserRank relevance ratings can be used alone or can be combined with other relevancy ranking methods to generate or modify the hitlist.

1) In the first alternate method consistent with this invention, the intermediate selections are taken into account in the order of their selection. Since the user continued to make selections after the first selection, later selections could indicate greater importance than earlier selections. The UserRank ordering of the hitlist for Search(A), starting with the first entry on the hitlist, is then:
PA(8), PA(3), PA(5), PA(1), PA(2), PA(4), PA(6), PA(7), PA(9), PA(10).

Note that an alternate ordering could order PA(5) before PA(3), to reflect that the prior user skipped over PA(3) in the original search to select PA(5).

2) In the second alternate method, the intermediate selections are ordered in the original order presented to the prior user, and only the final selection is treated as significant. The resulting hitlist ordering is then:
PA(8), PA(1), PA(2), PA(3), PA(4), PA(5), PA(6), PA(7), PA(9), PA(10).

Note that only PA(8) is moved up to the top of the hitlist.

3) In the third alternate method, intermediate selections are treated as distractions or indicators of negative quality/importance. If the prior user executes Search(A), and selects one or more intermediate entries, the intermediate entries are treated as if they have delayed the user from finding the “correct” or desired page. Continuing with the example described above, the intermediate selections are ordered further down on the hit list, as follows:
PA(8), PA(1), PA(2), PA(4), PA(6), PA(7), PA(9), PA(10), PA(3), PA(5)

Note that PA(3) and PA(5) are moved to the bottom of the list in this example, but they could have been moved to other less important locations on the list, but still below PA(8), such as:
PA(8), PA(1), PA(2), PA(4), PA(6), PA(7), PA(3), PA(5), PA(9), PA(10)
or
PA(8), PA(1), PA(2), PA(4), PA(6), PA(7), PA(5), PA(3), PA(9), PA(10)

Note that the position of entries PA(3) and PA(5) have been reversed.

It is to be understood that the embodiments and variations shown and described herein are merely illustrative of the principles of this invention and that various modifications may be implemented by those skilled in the art without departing from the scope and spirit of the invention.

1. A method for processing a document identified by a document search, comprising the steps of:
identifying a prior search having search terms that are sufficiently similar to search terms of said document search; and
assigning a weight to said document based on whether said document was selected by a user of said prior search.

2. The method of claim 1, wherein said assigned weight is based on an order of selection of two or more documents by said user.

3. The method of claim 1, wherein said assigned weight is utilized to rank said document identified by said document search.

4. The method of claim 1, wherein a final selection is assigned more weight than a non-final selection.

5. The method of claim 1, wherein a document entry in position n of a hitlist is assigned more weight than a document entry in position k of said hitlist if said document entry in position n is selected before said document entry in position k.

6. The method of claim 1, wherein said weight assigned to said document is correlated to a position of said document in a hitlist.

7. The method of claim 1, wherein said weight assigned to said document is correlated to a number of a page, wherein an entry identifying said document appears on said page.

8. The method of claim 1, wherein said weight assigned to said document is correlated to a degree of closeness of said search terms of said prior search and said search terms of said document search.

9. The method of claim 8, wherein a degree of closeness measurement correlates to a number of synonyms common between said search terms of said prior search and said search terms of said document search.

10. The method of claim 1, wherein a document selected by an expert is assigned more weight than a document entry selected by a non-expert.

11. The method of claim 1, wherein a weight assigned to said document is correlated to a ratio of the number of times said document was selected in a prior search and a number of prior search result hitlists, wherein said prior search result hitlists contain an entry identifying said document.

12. The method of claim 1, wherein a document corresponding to a non-final selection is assigned less weight than a document that is not selected by a user.

13. The method of claim 1, further comprising the step of storing said search terms of said document search and information describing selections by a user of said document search.

14. The method of claim 1, further comprising the step of storing said search terms of said document search and an ordered list of documents based on whether said documents were selected by a user.

15. An apparatus for processing a document identified by a document search, comprising:
a memory; and
at least one processor, coupled to the memory, operative to:
identify a prior search having search terms that are similar to search terms of said document search; and
assign a weight to said document based on whether said document was selected by a user of said prior search.

16. The apparatus of claim 15, wherein said assigned weight is based on an order of selection of two or more documents by said user.

17. The apparatus of claim 15, wherein said assigned weight is utilized to rank said document identified by said document search.

18. The apparatus of claim 15, wherein a final selection is assigned more weight than a non-final selection.

19. The apparatus of claim 15, wherein a document entry in position n of a hitlist is assigned more weight than a document entry in position k of said hitlist if said document entry in position n is selected before said document entry in position k.

20. The apparatus of claim 15, wherein said weight assigned to said document is correlated to a position of said document in a hitlist.

21. The apparatus of claim 15, wherein said weight assigned to said document is correlated to a number of a page, wherein an entry identifying said document appears on said page.

22. The apparatus of claim 15, wherein said weight assigned to said document is correlated to a degree of closeness of said search terms of said prior search and said search terms of said document search.

23. The apparatus claim 22, wherein a degree of closeness measurement correlates to a number of synonyms common between said search terms of said prior search and said search terms of said document search.

24. The apparatus of claim 15, wherein a document selected by an expert is assigned more weight than a document entry selected by a non-expert.

25. The apparatus of claim 15, wherein a weight assigned to said document is correlated to a ratio of the number of times said document was selected in a prior search and a number of prior search result hitlists, wherein said prior search result hitlists contain an entry identifying said document.

26. The apparatus of claim 15, wherein a document corresponding to a non-final selection is assigned less weight than a document that is not selected by a user.

27. The apparatus of claim 15, wherein said processor is further configured to store said search terms of said document search and information describing selections by a user of said document search.

28. The apparatus of claim 15, further comprising the step of storing said search terms of said document search and an ordered list of documents based on whether said documents were selected by a user.

29. An article of manufacture for processing a document identified by a document search, comprising a machine readable medium containing one or more programs which when executed implement the steps of:
identifying a prior search having search terms that are similar to search terms of said document search; and
assigning a weight to said document based on whether said document was selected by a user of said prior search.

30. The article of manufacture of claim 29, wherein said assigned weight is based on an order of selection of two or more documents by said user.

31. The article of manufacture of claim 29, wherein said assigned weight is utilized to rank said document identified by said document search.

32. The article of manufacture of claim 29, wherein said one or more programs which when executed further implement the step of storing said search terms of said document search and information describing selections by a user of said document search.

33. A method for processing a plurality of documents identified by a document search, comprising the steps of:
storing search terms of said document search; and
storing an ordered list of a plurality of said documents identified by said document search, where an order of said list is based on one or more user selections of said documents identified by said document search.
